(19) United States
(12) Patent Application Publication
(10) Pub. No.: US 2019/0146390 A1
(43) Pub. Date: May 16, 2019

(54) IMAGE FORMING APPARATUS

(71) Applicant: CANON KABUSHIKI KAISHA, Tokyo (JP)

(72) Inventor: Shohei Okumura, Tokyo (JP)

(21) Appl. No.: 16/183,765

(22) Filed: Nov. 8, 2018

(30) Foreign Application Priority Data
Nov. 10, 2017 (JP) 2017-217015
Jun. 4, 2018 (JP) 2018-107034

(51) Int. Cl. G03G 15/00; G03G 15/16

(52) U.S. Cl. CPC G03G 15/50; G03G 2215/1661; G03G 15/161

(57) ABSTRACT

An image forming apparatus includes: an image bearing member 1 which bears an image; a developing device 4 which includes a developing roller 41 bearing a liquid developer containing a toner and a carrier liquid and develops a latent image formed on the image bearing member; an intermediate transfer belt 91 to which a toner image formed on the image bearing member is transferred; a cleaning roller 11a which is applied a cleaning bias and configured to abut on the intermediate transfer belt and is made of a metal to collect a toner remaining on the intermediate transfer belt; a blade 11b which is provided to be able to abut on and be separated from the cleaning roller and is made of a metal to remove the liquid developer collected by the cleaning roller; a separation mechanism which makes the blade abut on and be separated from the cleaning roller; and a controller 200 which controls the separation mechanism to make the blade abut on the intermediate transfer belt after the carrier liquid from the developing roller is supplied to the image bearing member, according to a start of an image formation.

### BACKGROUND OF THE INVENTION

### Field of the Invention

The present invention relates to an image forming apparatus of an electrophotographic system which forms an image using a liquid developer.

### Description of the Related Art

Conventionally, an image forming apparatus which develops an electrostatic latent image formed on a rotating photosensitive drum into a toner image by using a liquid developer containing a toner and a carrier liquid, primarily transfers the developed toner image to an intermediate transfer member, and secondarily transfers the toner image transferred to the intermediate transfer member to a recording material has been known. In the image forming apparatus, the toner image is developed while the liquid developer contained in a developing container is supplied to a surface of a drum by a developing roller which abuts on the surface of the drum.

In addition, in the above-described apparatus, in order to remove the liquid developer containing the transfer residual toner remaining after the primary transfer from the surface of the drum, a cleaning blade (hereinafter, also simply referred to as a blade) which is made of a rubber or the like and formed in a plate shape abuts on an abutment position on the surface of the drum. However, if the blade is kept abutting on the photosensitive drum whose rotation is stopped, the blade sticks to the surface of the drum with an evaporation of the liquid developer remaining on the surface of the drum, or a streak-like adhered matter may be formed at the abutment position on the surface of the drum. To avoid this, the blade is provided to be able to abut on and be separated from the photosensitive drum, is separated from the surface of the drum when an image forming job ends, and controlled to abut on the surface of the drum when the image forming job starts (Japanese PCT National Publication No. 2008-508562).

In addition, an image forming apparatus capable of forming a color image is an image forming apparatus which uses a dry developer instead of a liquid developer, but a tandem type image forming apparatus in which a plurality of photosensitive drums is arranged side by side in a movement direction of an intermediate transfer belt is proposed in the related art (Japanese Patent Laid-Open No. 2010-66452).

Recently, to further reduce a size of the image forming apparatus using the liquid developer, there is a demand to configure the image forming apparatus using the intermediate transfer belt as described in Japanese Patent Laid-Open No. 2010-66452.

In the image forming apparatus using the liquid developer as described above, the image forming apparatus using the intermediate transfer belt needs to collect the toner remaining on the intermediate transfer belt. As a cleaning device which collects the toner remaining on the intermediate transfer member, a configuration to make a cleaning roller of metal abut on the intermediate transfer belt and apply a cleaning bias to the cleaning roller to electrically collect the toner is considered. The toner collected by the cleaning roller is collected by the cleaning blade which is made of metal and abuts on the cleaning roller.

In such a configuration, if the cleaning roller is rotated in a state in which the liquid developer is not supplied to the cleaning roller, it has been found that the cleaning blade is extremely worn by a frictional force between the cleaning roller and the cleaning blade. As a result, the cleaning roller is damaged. In addition, a scraped piece may be generated between the cleaning blade and the cleaning roller. These can cause image defects.

### SUMMARY OF THE INVENTION

The present invention is made in view of the above problem. That is, it is desirable to suppress a defect caused by a rotation of a metal roller while a metal blade abuts on the metal roller in a state in which a liquid developer is not supplied to the metal roller.

An image forming apparatus of the present invention has the following:

an image bearing member which bears an image;

a developing device which includes a developing roller bearing a liquid developer containing a toner and a carrier liquid and develops a latent image formed on the image bearing member;

an intermediate transfer belt to which a toner image formed on the image bearing member is transferred;

a cleaning roller which is applied a cleaning bias and configured to abut on the intermediate transfer belt and is made of a metal to collect a toner remaining on the intermediate transfer belt;

a blade which is provided to be able to abut on and be separated from the cleaning roller and is made of a metal to remove the liquid developer collected by the cleaning roller;

a separation mechanism which makes the blade abut on and be separated from the cleaning roller; and

a controller which controls the separation mechanism to make the blade abut on the intermediate transfer belt after the carrier liquid is supplied from the developing roller to the image bearing member, according to a start of an image formation.

Further features of the present invention will become apparent from the following description of exemplary embodiments with reference to the attached drawings.

### BRIEF DESCRIPTION OF THE DRAWINGS

FIG. 1 is a schematic diagram showing a configuration of an image forming apparatus according to the present embodiment.

FIG. 2 is a cross-sectional view showing a configuration of an image forming portion.

FIG. 3 is a control block diagram of an abutment and separation control according to a first embodiment.

FIGS. 4A and 4B are each cross-sectional structural views of a cleaning device according to the first embodiment, in which FIG. 4A is a view in which a cleaning blade is positioned at an abutment position, and FIG. 4B is a view in which the cleaning blade is positioned at a separation position.

FIG. 5 is a flowchart of an abutment sequence according to the first embodiment.

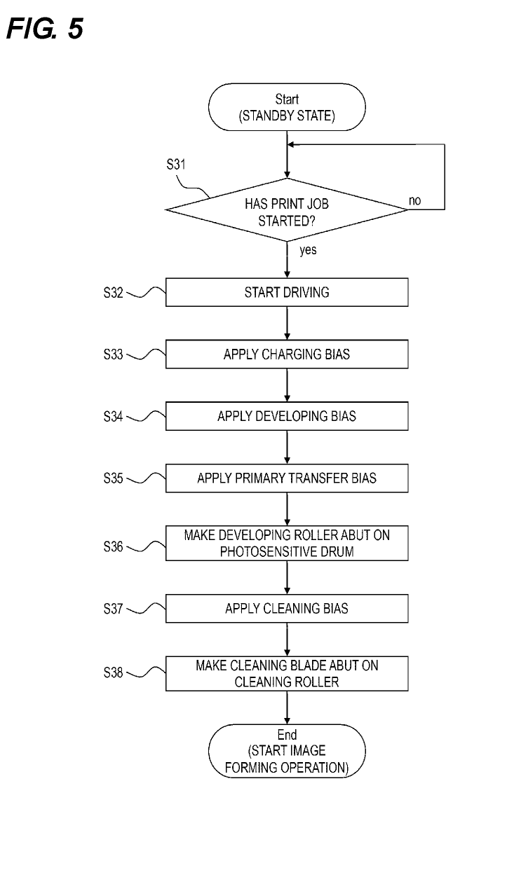

FIG. 6 is a timing chart of the abutment sequence according to the first embodiment.

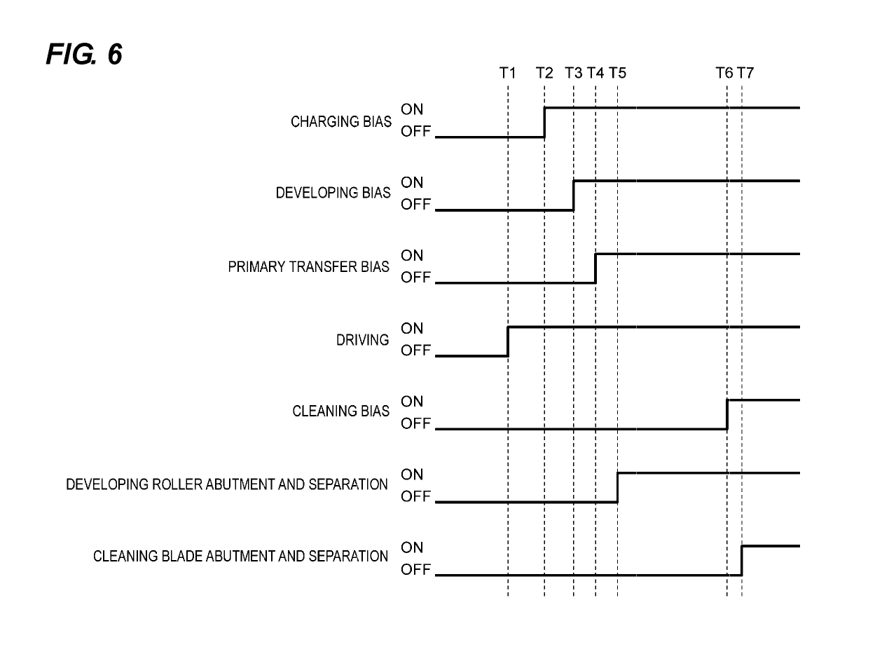

FIG. 7 is a flowchart of a separation sequence according to the first embodiment.

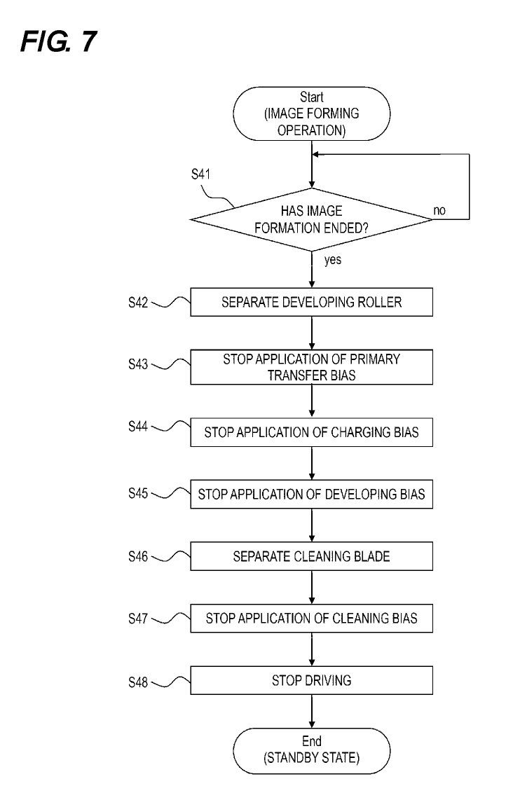

FIG. 8 is a timing chart of the separation sequence according to the first embodiment.

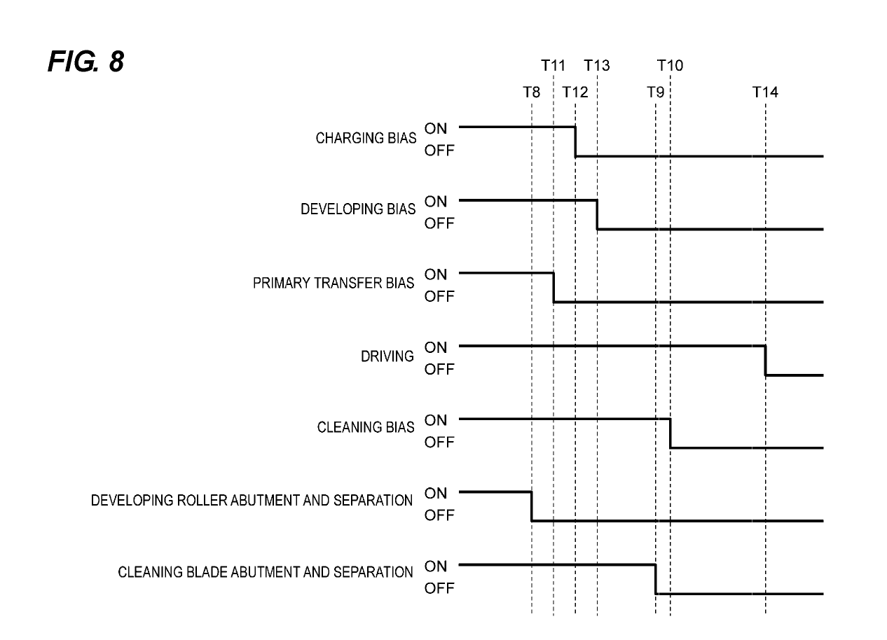

FIGS. 9A and 9B are each cross-sectional structural views of a cleaning device according to a second embodiment, in which FIG. 9A is a view in which the cleaning device is positioned at an abutment position, and FIG. 9B is a view in which the cleaning device is positioned at a separation position.

FIG. 10 is a control block diagram of an abutment and separation control according to the second embodiment.

FIG. 11 is a flowchart of an abutment sequence according to the second embodiment.

FIG. 12 is a timing chart of the abutment sequence according to the second embodiment.

FIG. 13 is a flowchart of a separation sequence according to the second embodiment.

FIG. 14 is a timing chart of the separation sequence according to the second embodiment.

### DESCRIPTION OF THE EMBODIMENTS

### First Embodiment

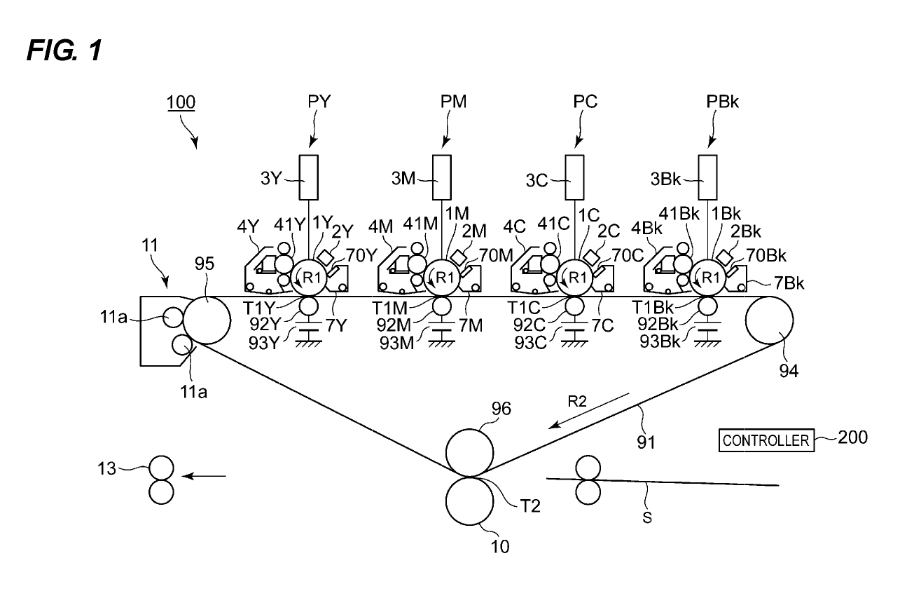

A first embodiment will be described. First, a schematic configuration of an image forming apparatus according to the present embodiment will be described with reference to FIG. 1.

### [Image Forming Apparatus]

An image forming apparatus 100 according to the present embodiment is a full color printer of a tandem type intermediate transfer system in which a plurality of image forming portions PY, PM, PC, and PBk is arranged. In the present embodiment, the four image forming portions PY to PBk are arranged at equal intervals in series in a moving direction of an intermediate transfer belt 91, and are arranged in the order of yellow, magenta, cyan, and black from an upstream side in the moving direction.

The image forming apparatus 100 can output, to a recording material S, a color image formed according to image information from an external host apparatus (not shown) such as a personal computer or an image reading apparatus capable of communicating with a main body of the image forming apparatus. Examples of the recording material S may include a cut sheet having an average basis weight of 60 to 350 g/m², an over head transparency (OHT) sheet, and the like. In the case of outputting the color image, the image forming apparatus 100 generates a color-separated image signal according to a print signal transmitted from the external host apparatus, and forms toner images of each color by each of the image forming portions PY to PBk according to the image signal. The image forming apparatus 100 continuously multiple-transfers the toner images of each color formed by the image forming portions PY to PBk to the intermediate transfer belt 91 that moves in a predetermined direction, and then transfers the toner images, which are multiple-transferred from the intermediate transfer belt 91, to the recording material S at a time. The recording material S to which the toner images are transferred at a time is conveyed to a fixing device 13. The recording material S is conveyed to the fixing device 13 to be heated and pressurized, or irradiated with ultraviolet light, such that the toner image is fixed to the recording material S. The recording material S to which the toner image is fixed by the fixing device 13 is discharged to an outside of a machine body. In this manner, the color image is output to the recording material S

### [Image Forming Portion]

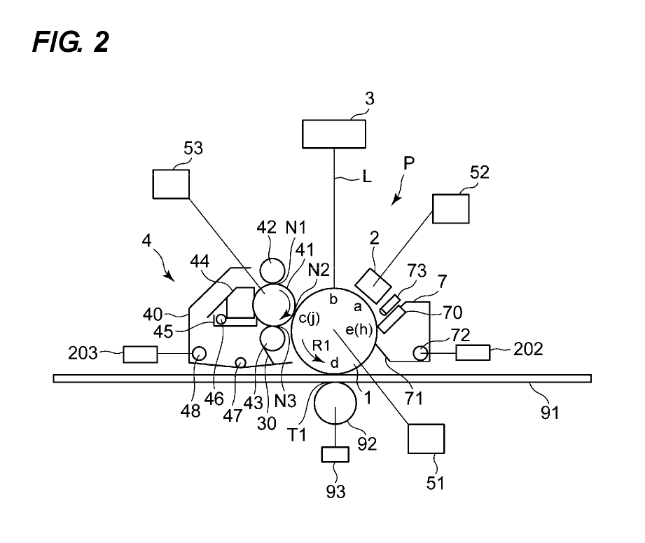

The image forming portions PY to PBk which form images of each color of yellow (Y), magenta (M), cyan (C), and black (Bk) will be described with reference to FIG. 2. However, since the image forming portions PY to PBk are configured identically except that colors of toners used in developing devices 4Y to 4Bk are different, the image forming portions PY to PBk will be described with omission of Y, M, C, and Bk at the end of reference numerals assigned to distinguish the respective image forming portions PY to PBk unless there is a need to particularly distinguish the image forming portions.

As shown in FIG. 2, in an image forming portion P, a charging device 2, an exposure device 3, a developing device 4, and a drum cleaning device 7 are arranged surrounding a photosensitive drum 1. The photosensitive drum 1 as a first image bearing member or a second image bearing member is a photoconductor having an amorphous silicon photosensitive layer formed on an outer peripheral surface of a conductive aluminum cylinder or an organic photoconductor (OPC) drum. In the first embodiment, the photosensitive drum 1 which has an outer diameter of 84 mm and a longitudinal width (length in a rotational axis direction) of 380 mm was used. The photosensitive drum 1 is rotated in a direction of an arrow R1 in the drawing at a process speed of, for example, a circumferential velocity of 500 mm/sec by a drum driving motor 51. Generally, the photosensitive drum 1, a developing roller 41, and the intermediate transfer belt 91 are all driven at the same process speed.

The charging device 2 is, for example, a corona charger of a scorotron system, and charges a surface of the photosensitive drum 1 with a uniform negative dark portion potential (for example, −500 V). The corona charger charges the surface of the photosensitive drum 1 by applying a DC voltage from a charging power supply 52 to a discharge wire which is shielded with a metal such as aluminum, has a diameter of about 50 to 100 and is made of tungsten or stainless steel.

The photosensitive drum 1 is charged by the charging device 2 and then is subjected to image exposure (laser light L) by the exposure device 3. The exposure device 3 generates a laser beam, which is obtained by ON-OFF modulating scanning line image data obtained by developing separated color images of each color, from a laser light emitting element, and scans the generated laser beam with a rotation mirror to write an electrostatic latent image of an image onto the charged surface of the photosensitive drum 1. By such laser scanning exposure, a potential of a spot on the surface of the drum which is irradiated with the laser beam L becomes lower than that of other spots, so that the electrostatic latent image corresponding to the image information is formed. In the first embodiment, the potential of the exposed portion was −100 V

### [Liquid Developer]

Next, the electrostatic latent image formed on the photosensitive drum 1 is developed by the developing device 4 using the liquid developer. The developing device 4 as a first developing unit or a second developing unit contains the liquid developer in which a particulate toner as a dispersoid is dispersed in a carrier liquid as a dispersion medium, and the developing device 4 performs development using the liquid developer. As the liquid developer, a liquid developer having a viscosity of 0.5 to 100 cP can be used. In the first embodiment, a liquid developer in which a resin-made toner which contains a pigment of each color of yellow, magenta, cyan, and black and has a center particle size of 1 μm is dispersed in a carrier liquid which is made of a silicon solvent, a hydrocarbon, an ether, or the like and has a volume resistivity of 1×10¹⁰ Ω·cm or more was used. Of course, the liquid developer is not limited thereto, and for example, a liquid developer of a type curable by ultraviolet light may be used.

[Developing Device]

The configuration and developing operation of the developing device 4 will be described. As shown in FIG. 2, the developing device 4 includes a developing container 40 which forms a casing, the developing roller 41, a squeeze roller 42, a cleaning roller 43, an electrode segment 44, a supply tray 45, a removing member 30, and the like.

The developing container 40 contains a liquid developer containing a monochromatic toner and a carrier liquid. As shown in FIG. 2, a part of the developing container 40 facing the photosensitive drum 1 is open, and the developing roller 41 is rotatably provided so as to be partially exposed in the opening part. The developing roller 41 has a cylindrical shape and is rotated in the same direction on a surface facing the photosensitive drum 1. The electrode segment 44 is provided on an opposite side to a surface of the developing roller 41 facing the photosensitive drum 1, and is disposed to be opposed at a predetermined gap (for example, 0.5 mm) therebetween. The supply tray 45 is disposed below the electrode segment 44, and the liquid developer is pumped up from the supply tray 45 to the gap by a torque of the developing roller 41. The supply tray 45 temporarily stores the liquid developer supplied from a mixer (not shown) so that the developing roller 41 can pump up the liquid developer by the rotation.

The electrode segment 44 forms an electric field between the electrode segment 44 and the developing roller 41 by applying a voltage of, for example, −500 V by a power supply (not shown). By the electric field, the toner contained in the liquid developer pumped up to the gap comes close to the surface side of the developing roller 41. The squeeze roller 42 is disposed on a downstream side in a rotation direction of the developing roller 41 with respect to the electrode segment 44. The squeeze roller 42 abuts on the developing roller 41 to form a nip portion N1. Among the liquid developers on the developing roller 41 that passes through an opposite region to the electrode segment 44, the toner and a part of the carrier liquid which come close to the surface side of the developing roller 41 pass through the nip portion N1 of the squeeze roller 42. The liquid developer not passing through the nip portion N1 of the squeeze roller 42 flows along an upper surface of the electrode segment 44 and drops to a bottom side of the developing container 40. The power supply (not shown) applies a voltage of, for example, −350 V to the squeeze roller 42.

In the case of the first embodiment, the developing device 4 is provided to be rotatable about a rotation shaft 48. The developing roller 41 is provided to be able to abut on and be separated from the photosensitive drum 1. As the developing device 4 is rotated, the developing roller 41 can move between a position at which the developing roller 41 abuts on the photosensitive drum 1 at a predetermined pressure (for example, 30 N) to be able to supply the liquid developer and a position further separated from the photosensitive drum 1 with respect to the suppliable position. A developing power supply 53 applies a developing voltage of, for example, −300 V while the photosensitive drum 1 abuts on the developing roller 41. In this case, the liquid developer passing through the nip portion N1 of the squeeze roller 42 is conveyed to a developing position c, such that the electrostatic latent image on the photosensitive drum 1 is developed into a toner image. That is, the toner in the liquid developer conveyed to the developing position c is selectively attached to the electrostatic latent image formed on the photosensitive drum 1 by the electric field generated by the developing voltage. In this way, the electrostatic latent image on the photosensitive drum 1 is developed into the toner image. The developing position c is a predetermined position in a rotation direction of the photosensitive drum 1 which can develop the electrostatic latent image formed on the photosensitive drum 1 into the toner image by the liquid developer and is a developing nip portion N2 which is formed by the developing roller 41 and the photosensitive drum 1.

The cleaning roller 43 is disposed on a downstream side in the rotation direction of the developing roller 41 with respect to the developing nip portion N2. The cleaning roller 43 collects the toner, which is contained in the liquid developer remaining on the developing roller 41 after passing through the developing nip portion N2, by using an electrostatic force and applies a pressure to the carrier liquid in a collection nip portion N3 after the toner collection to remove the carrier liquid. A removing member 30 is disposed on the downstream side in the rotation direction of the cleaning roller 43 with respect to the collection nip portion N3. The removing member 30 is a plate-like elastic member extending in a longitudinal direction of the cleaning roller 43 and abuts on the cleaning roller 43 to scrape off the toner or the carrier liquid on the cleaning roller 43. The carrier liquid removed by the cleaning roller 43 or the toner or the carrier liquid scraped off by the removing member 30 drops to the bottom side of the developing container 40. The power supply (not shown) applies a voltage of, for example, −150 V to the cleaning roller 43.

The liquid developer which drops to the bottom side of the developing container 40 returns to a mixer (not shown) and is reused. To this end, an outlet 47 communicating with the mixer is provided on the bottom side of the developing container 40, and the liquid developer is discharged through the outlet 47.

Returning to the description of the image forming portion, the toner images of each color formed on the photosensitive drum 1 are primarily transferred by being sequentially superimposed on the intermediate transfer belt at a primary transfer position d. A primary transfer roller 92 is provided on an inner peripheral surface side of the intermediate transfer belt 91 to face the photosensitive drum 1, having the intermediate transfer belt 91 sandwiched therebetween. The primary transfer roller 92 is made of, for example, a conductive sponge and presses the intermediate transfer belt 91 to form a primary transfer nip portion T1 between the photosensitive drum 1 and the intermediate transfer belt 91. The primary transfer position d as a first transfer position or a second transfer position is the primary transfer nip portion T1. The primary transfer roller 92 is kept pressed against the intermediate transfer belt 91 until the photosensitive drum 1 and the intermediate transfer belt 91 are stopped. The primary transfer roller 92 is connected to a primary transfer voltage power supply 93 which applies a primary transfer voltage as a first transfer voltage or a secondary transfer voltage. The primary transfer voltage (for example, +200 V) is applied to the primary transfer roller 92, so that the primary transfer of the toner image from the photosensitive drum 1 to the intermediate transfer belt 91 is performed at the primary transfer position d. In the case of the first embodiment, the primary transfer roller 92 and the primary transfer voltage power supply 93 are combined to function as the first transfer unit or the second transfer unit. The primary transfer residual toner remaining on the photosensitive drum 1 (on the first image bearing member and on the second image bearing member) without being transferred to the intermediate transfer belt 91 at the primary transfer position d is removed from the photosensitive drum 1 by the drum cleaning device 7.

### [Drum Cleaning Device]

The drum cleaning device 7 includes a blade 70 and a scooping sheet 71. The blade 70 as a first blade or a second blade is disposed on the upstream side in the rotation direction of the photosensitive drum 1 with respect to the above-described developing position c and the downstream side in the rotation direction of the photosensitive drum 1 with respect to the above-described primary transfer position d. The blade 70 abuts on the photosensitive drum 1 at an abutment position e, and cleans the photosensitive drum 1 by mechanically scraping off the primary transfer residual toner. The blade 70 is made of a urethane rubber-based material having, for example, a JIS-A rubber hardness of 80° and is formed in a plate shape having a thickness of 3 mm and a longitudinal width of 370 mm. For example, the blade 70 abuts on the photosensitive drum 1 in a counter direction at an angle of about 25° so that a penetration amount of the blade 70 into the surface of the drum is about 0.5 mm at a free length of, for example, 10 mm. In the case of the first embodiment, the drum cleaning device 7 is provided to be rotatable about a unit rotation shaft 72. As the drum cleaning device 7 rotates, the blade 70 can move between a position at which the blade 70 abuts on the photosensitive drum 1 to be able to remove a toner and a position separated from the photosensitive drum 1 with respect to the removable position.

The scooping sheet 71 abuts on the photosensitive drum 1 on the upstream side in the rotation direction of the photosensitive drum 1 with respect to the blade 70 to store a predetermined amount (for example, about 10 mm) of liquid developer between the surface of the rotating photosensitive drum 1 and the blade 70. The scooping sheet 71 is made of, for example, polyethylene terephthalate (PET) and is formed in a plate shape having a thickness of 0.05 mm and a longitudinal width of 370 mm. For example, the scooping sheet 71 abuts on the photosensitive drum 1 at an angle of about 30° so that a penetration amount of the blade 70 into the surface of the drum is about 1.0 mm at a free length of, for example, 10 mm.

A neutralizing device 73 including an LED array having a central wavelength of, for example, 680 nm is disposed on the downstream side in the rotation direction of the photosensitive drum 1 with respect to the drum cleaning device 7. In order to lower the potential of the surface of the photosensitive drum 1 to a predetermined potential (for example, 0 V), the neutralizing device 73 is adjusted so that the exposure amount is, for example, about 3 μJ/cm² on the surface of the drum.

Returning to FIG. 1, the intermediate transfer belt 91 is stretched across a tension roller 94, a driving roller 95, and a secondary transfer inner roller 96, and is driven by the driving roller 95 to be rotated in a direction of an arrow R2 in the drawing. As described above, the toner images primarily transferred by being sequentially superimposed on the intermediate transfer belt are collectively secondarily transferred onto a recording material S conveyed to a secondary transfer portion T2. The secondary transfer portion T2 is a toner image transfer nip portion to the recording material S formed by making a secondary transfer outer roller 10 abut on the intermediate transfer belt 91 stretched toward the secondary transfer inner roller 96. In the secondary transfer portion T2, a power supply (not shown) applies a secondary transfer voltage to the secondary transfer outer roller 10, so that the toner image is secondarily transferred from the intermediate transfer belt 91 to the recording material S.

The secondary transfer residual toner remaining while sticking to the intermediate transfer belt 91 (on the intermediate transfer member) after the secondary transfer is collected by a belt cleaning device 11. The belt cleaning device 11 has a metal roller 11a, and the metal roller 11a rubs the intermediate transfer belt 91 to remove the secondary transfer residual toner from the intermediate transfer belt 91. At this time, the power supply (not shown) applies a voltage of, for example, +100 V to the metal roller 11a.

As the intermediate transfer belt 91, a resin belt, a rubber belt containing a metal core body, a belt made of resin and rubber, or the like can be suitably used. In the first embodiment, a two-layered resin belt in which an electric resistance of the entire belt is controlled by using, for example, nitrile butadiene rubber (NBR) of 200 μm on a surface layer and polyimide (PI) of 50 μm on a base layer and dispersing carbon in the base layer was used. In addition, the intermediate transfer belt 91 having a longitudinal width of 360 mm and the whole circumference of 3500 mm was used.

### [Cleaning Device]

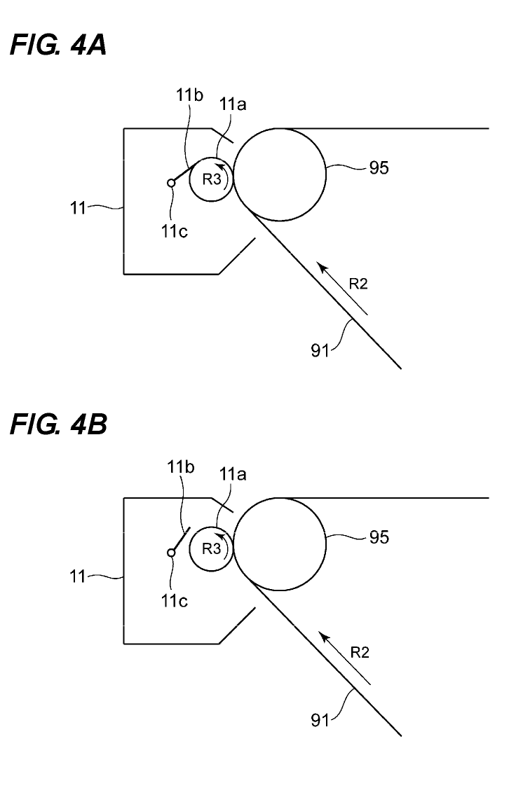

FIGS. 4A and 4B are each cross-sectional structural views of a belt cleaning device 11 (hereinafter, referred to as a cleaning device) according to the first embodiment. FIGS. 4A and 4B each show an abutment and separation state of a cleaning blade to be described below. The cleaning device 11 includes a cleaning container as a casing, a cleaning roller 11a, a cleaning blade 11b, and the like.

A part of the cleaning container facing the intermediate transfer belt 91 is open, and the cleaning roller 11a is provided so as to be partially exposed in the opening part. The cleaning roller 11a is a cylindrical member of SUS, and is provided so as to be rotatable about an axis and pressed against a counter roller 95 at a predetermined pressure (for example, 30 N), having the intermediate transfer belt 91 interposed therebetween, and a nip portion is formed between the cleaning roller 11a and the intermediate transfer belt 91. In the first embodiment, a belt driving roller 95 serves as the counter roller.

The cleaning roller 11a is rotationally driven by a driving unit so that a surface speed of an outer peripheral surface thereof is substantially equal to that of the intermediate transfer belt 91 at the nip portion. Further, the cleaning roller 11a is connected to a cleaning roller high voltage power supply 205, and is applied with a cleaning bias having an opposite-polarity to that of the secondary transfer residual toner. As a result, the secondary transfer residual toner on the intermediate transfer belt 91 is collected at the nip portion. Hereinafter, the nip portion is referred to as a transfer cleaning portion.

The cleaning blade 11b is a plate-like metal blade extending in an axial direction of the cleaning roller 11a. In the first embodiment, a material of the cleaning blade 11b is SUS (stainless steel material). The cleaning blade 11b is disposed on a downstream side of the transfer cleaning portion in the rotation direction of the cleaning roller 11a. The cleaning blade 11b abuts on a surface of the cleaning roller 11a to penetrate by about 1 mm at a predetermined angle (for example, 45°). By doing so, the collected toner on the cleaning roller 11a is scraped off. The scraped off toner drops to the bottom of the cleaning container.

The cleaning blade 11b is provided so as to be rotatable about a rotation shaft 11c. The cleaning blade 11b can move between a position at which the cleaning blade 11b abuts on the cleaning roller 11a by a rotation operation by a cleaning blade abutment and separation unit 206 to be able to remove a toner and a position separated from the cleaning roller 11a. As described above, FIGS. 4A and 4B each show the abutment position and the separation position.

Although the cleaning roller 11a can be made of a material other than the SUS, the cleaning roller 11a has conductivity, forms the nip portion at the time of pressurization, and needs not to damage these functions even when abutting on the cleaning blade 11b. In addition, a friction coefficient between the cleaning roller 11a and the cleaning blade 11b is 0.4 to 1.5 in the state in which the liquid developer is not supplied and 0.02 to 0.08 in the state in which the liquid developer is supplied.

### [Controller]

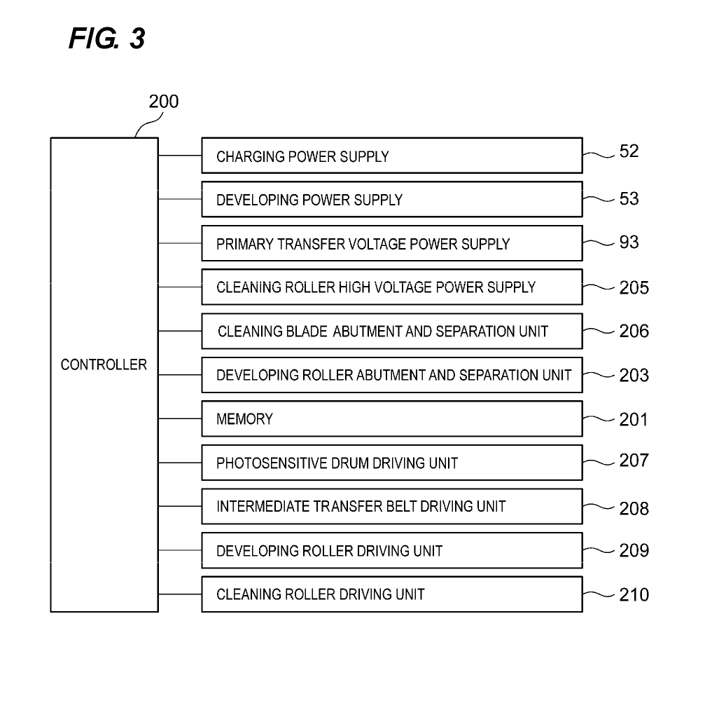

The image forming apparatus 100 of the first embodiment includes a controller 200. The controller 200 will be described with reference to FIGS. 2 and 3. In addition to the components shown in the drawing, various components such as a motor and a power supply for operating the image forming apparatus 100 are connected to the controller 200. However, these components are not the purpose of the present invention, and therefore the illustration and explanation thereof are omitted.

The controller 200 as a control unit performs various controls of the image forming apparatus 100, such as an image forming operation, and has a central processing unit (CPU) (not shown). A ROM or a RAM as a memory unit or a memory 201 such as a hard disk device is connected to the controller 200. Various programs, data, and the like for controlling the image forming apparatus 100 are stored in the memory 201. The controller 200 may execute an image forming job stored in the memory 201 and operates the image forming apparatus 100 so as to form an image. In the case of the first embodiment, the controller 200 can execute a separation control to separate the blade 70 and the developing roller 41 from the photosensitive drum 1 at the end of the image forming job (that is, at the time of post-rotation). The separation control will be described later (see FIG. 4). It is to be noted that the memory 201 temporarily stores calculation processing results accompanied by the execution of various control programs and the like.

The image forming job is a series of operations from a start of the image formation to a completion of the image forming operation based on the print signal for forming the image on the recording material S. That is, the image forming job is a series of operations from a start of a preliminary operation (so-called pre-rotation) required to perform the image formation to a completion of a preliminary operation (so-called post-rotation) required to complete the image formation through the image forming process. Specifically, the image forming job includes an image forming period and a sheet interval and indicates a period from pre-rotation (preparation operation before image formation) to post-rotation (operation after image formation) after receiving the print signal (reception of the image forming job). In the present specification, the term “post-rotation” refers to a period from the end of the last image formation of the image forming job to the stop of the rotation of the photosensitive drums 1Y to 1Bk, the intermediate transfer belt 91, or the like which is continuously rotated without forming the toner image.

In addition to the memory 201, a charging power supply 52, a developing power supply 53, a primary transfer voltage power supply 93, a cleaning blade abutment and separation unit 206, a developing roller abutment and separation unit 203, and a display portion 204 are connected to the controller 200. In addition, a cleaning roller high voltage power supply 205, a photosensitive drum driving unit 207, a developing roller driving unit 209, and a cleaning roller driving unit 210 are connected to the controller 200. As described above, the charging power supply 52 applies a DC voltage to the charging device 2 to allow the charging device 2 to charge the surface of the photosensitive drum 1. The developing power supply 53 applies a developing voltage to the developing roller 41 to cause the developing roller 41 to develop the electrostatic latent image on the photosensitive drum 1 into the toner image using the liquid developer. The primary transfer voltage power supply 93 applies a primary transfer voltage to a primary transfer roller 92 to primarily transfer the toner image formed on the photosensitive drum 1 to the intermediate transfer belt 91.

The cleaning blade abutment and separation unit 206 is a motor, an operating mechanism, or the like which rotates the belt cleaning device 11 about the unit rotation shaft 11c. The developing roller abutment and separation unit 203 is the motor, the operating mechanism, or the like which rotates the developing device 4 about the rotation shaft 48. The display portion 204 is, for example, a liquid crystal display or the like on which a menu or the like which presents a user with various control programs such as an operation state of the apparatus main body and an executable image forming jobs is displayed. It is to be noted that the controller 200 may display a virtual operator on the display portion 204 and may be able to receive an execution start operation, a data input operation, or the like of the image forming job by a user using the virtual operator.

Here, in the belt cleaning device 11 of the intermediate transfer belt 91, when the cleaning blade 11b abuts on the cleaning roller 11a in the state in which no liquid developer is present at the blade abutment position, the frictional force is significantly increased as compared with the case in which the liquid developer is present. As a result, the cleaning blade 11b and the cleaning roller 11a may be worn or the cleaning roller 11a may be damaged. However, it is generally difficult to restore the cleaning blade 11b and the cleaning roller 11a to the original state without maintenance in such a state.

Therefore, in the first embodiment, the cleaning blade is separated from the cleaning roller in the state in which the liquid developer is not supplied to the cleaning roller to suppress these problems from occurring. This will be described below.

The control in the first embodiment will be described below with reference to a control block diagram, a flowchart, and a timing chart. Since the sequences of the abutment operation and the separation operation of the cleaning blade 11b are different, they will be described separately.

First, the sequence of the abutment operation of the cleaning blade will be described.

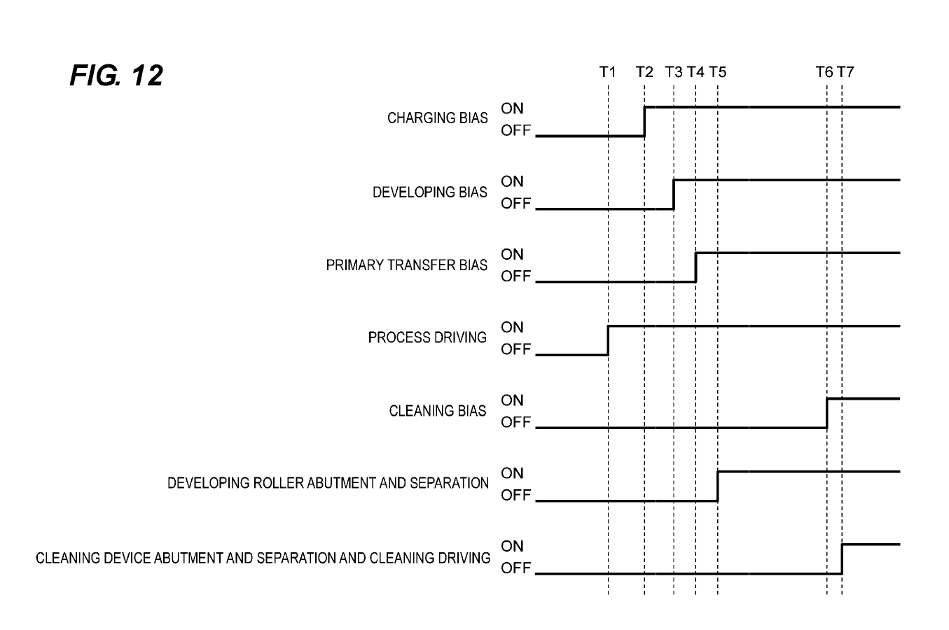

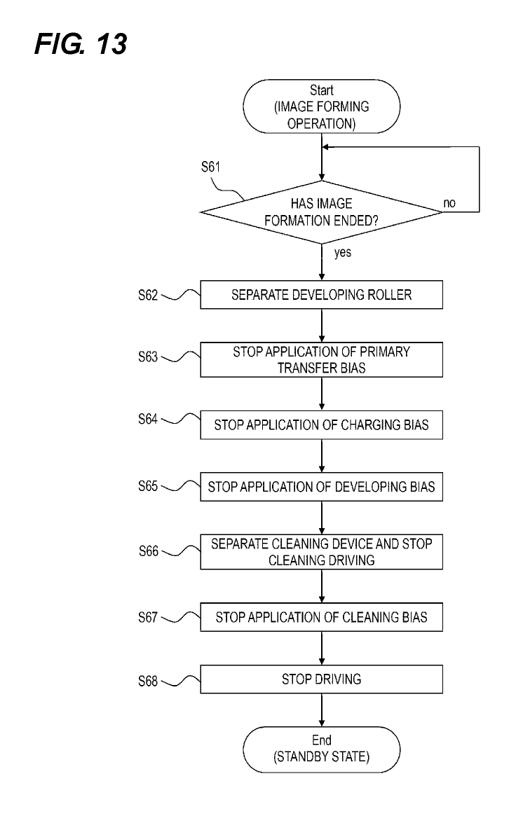

FIGS. 12 and 13 are each diagrams illustrating a flow of the sequence of the abutment operation of the cleaning blade and timings of each step of the sequence in the first embodiment.

An initial state of this sequence indicates a standby state before the print signal is received. At this time, all the driving of the photosensitive drum 1, the developing roller 41, the intermediate transfer belt 91 (hereinafter, also referred to as intermediate transfer member), and the cleaning roller 11a are stopped, and a charging bias, a developing bias, a primary transfer bias, and the cleaning bias are not applied. Further, the developing roller 41 and the cleaning blade 11b are separated from the photosensitive drum 1 and the cleaning roller 11a, respectively. In this state, since no liquid developer is supplied from the developing roller 41 to the photosensitive drum 1, no developer is also supplied to the intermediate transfer member 91 or the cleaning roller 11a.

In this sequence, since the driving of each of the photosensitive drum 1, the developing roller 41, the intermediate transfer member 91, and the cleaning roller 11a is all simultaneously input, they are collectively referred to as a driving hereinafter.

When the controller receives the print signal and the job is started, the driving is started at time T1 (S32).

The charging bias is applied at an arbitrary timing T2 after the driving ON (S33). As a result, the surface of the photosensitive drum 1 is charged. In this sequence, the photosensitive drum 1 is not exposed. By controlling in this way, the potential of the surface of the photosensitive drum 1 in the sequence is kept at a potential of the dark part.

The primary transfer bias is applied at an arbitrary timing T4 after a front end of the charging portion of the photosensitive drum 1 reaches the primary transfer portion T1 (S35). As a result, a primary transfer current is supplied to the photosensitive drum 1 through the primary transfer portion T1.

The developing roller 41 abuts on the photosensitive drum 1 at an arbitrary timing T5 after a front end of a primary transfer current supplying portion of the photosensitive drum 1 reaches the developing nip portion N2 (S36).

While the developing roller 41 abuts on the photosensitive drum 1, the liquid developer is continuously supplied to the photosensitive drum 1.

The developing bias is applied at an arbitrary timing T3 between the timings T2 and T5 (S34). At this time, as the potential of the surface of the photosensitive drum 1 is kept at the potential of the dark part, the liquid developer moving from the developing roller 41 to the photosensitive drum 1 contains almost no toner particles, and is mainly made of the carrier liquid.

The liquid developer supplied to the photosensitive drum 1 is supplied to the intermediate transfer member 91 through the primary transfer portion T1.

The cleaning bias is applied at an arbitrary timing T6 before a front end of the liquid developer on the intermediate transfer member 91 reaches the transfer cleaning portion (S37). By doing so, it is possible to collect a slight fog toner present in the carrier liquid supplied to the intermediate transfer member 91.

The liquid developer supplied to the intermediate transfer member 91 is supplied to the cleaning roller 11a through the transfer cleaning portion.

The cleaning blade 11b abuts on the cleaning roller 11a at an arbitrary timing T7 after the liquid developer supplied to the cleaning roller 11a reaches the abutment position of the cleaning blade 11b(S38). The abutment sequence of the cleaning blade 11b is completed, and the process proceeds to an image forming operation or other preliminary operations. In the first embodiment, the controller controls the cleaning blade 11b to abut on the cleaning roller 11a after a lapse of a predetermined time since the developing roller 41 abuts on the photosensitive drum 1. In addition, in the first embodiment, the blade abuts on the cleaning roller before a first image of the image forming job is transferred to the intermediate transfer belt. In addition, the timing at which the cleaning blade 11b abuts on the cleaning roller 11a may be the same as the timing at which the front end of the liquid developer reaches the abutment position of the cleaning blade 11b.

If an arbitrary timing T7 is set after the liquid developer reaches the abutment position of the cleaning blade 11b, the cleaning blade 11b abuts on the cleaning roller 11a in the state in which the liquid developer is present at the abutment position of the cleaning blade 11b. Therefore, it is possible to reduce the frictional force between the cleaning blade 11b and the cleaning roller 11a. In the first embodiment, T7 is set substantially simultaneously with the timing at which the liquid developer reaches the abutment position of the cleaning blade 11b. By the setting described above, it is possible to prevent an extra liquid developer from turning along the intermediate transfer member 91.

Subsequently, the separation operation of the cleaning blade will be described.

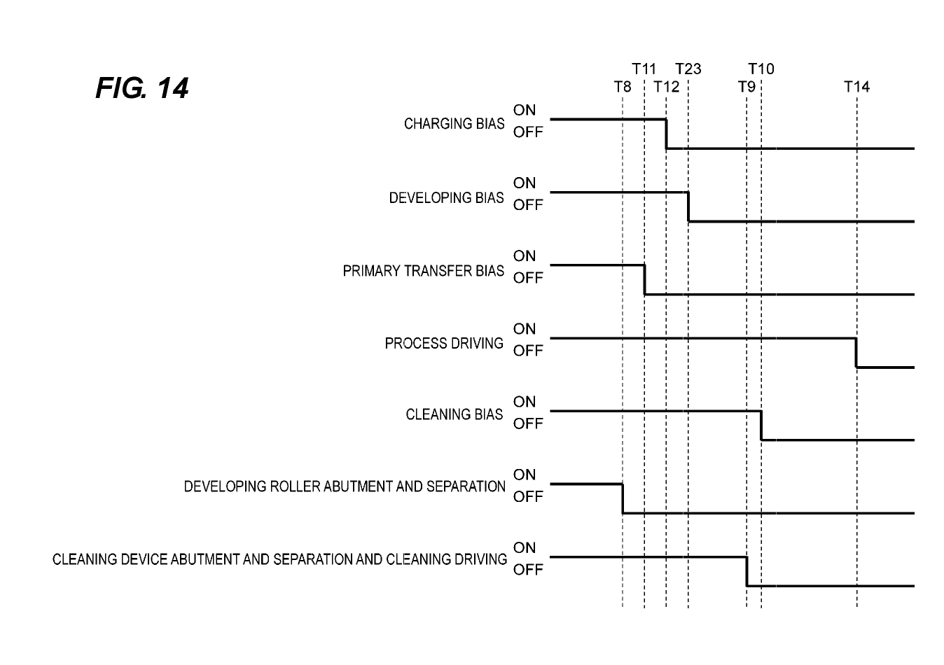

FIGS. 14 and 15 are each diagrams illustrating a flow of the sequence of the abutment operation of the cleaning blade and the timings of each step of the sequence in the first embodiment.

The initial state of this sequence refers to the image forming operation or other preliminary operations. At this time, the photosensitive drum 1, the developing roller 41, the intermediate transfer member 91, and the cleaning roller 11a are all driven, and the charging bias, the developing bias, the primary transfer bias, and the cleaning bias are applied. Further, the developing roller 41 and the cleaning blade 11b abut on the photosensitive drum 1 and the cleaning roller 11a, respectively. In this state, the liquid developer is continuously supplied from the developing roller 41 to the photosensitive drum 1, and the liquid developer is also supplied to the intermediate transfer member 91 or the cleaning roller 11a through the primary transfer portion T1 or the cleaning portion.

In this sequence, since the driving of each of the photosensitive drum 1, the developing roller 41, the intermediate transfer member 91, and the cleaning roller 11a is all simultaneously input, they are collectively referred to as driving hereinafter.

After the completion of the image forming operation or other preliminary operations, the photosensitive drum 1 is not exposed. As a result, the potential of the surface of the photosensitive drum 1 is kept at the potential of the dark part during the application of the charging bias, and the liquid developer moving from the developing roller 41 to the photosensitive drum 1 contains almost no toner particles, and is mainly made of the carrier liquid.

The developing roller 41 is separated from the photosensitive drum 1 at an arbitrary timing T8 after the completion of the image forming operation or other preliminary operations (S42). As a result, the continuous supply of the liquid developer from the developing roller 41 to the photosensitive drum 1 is interrupted.

The supply of the liquid developer from the developing roller 41 to the photosensitive drum 1 is interrupted, and thus the supply of the liquid developer to the intermediate transfer member 91 or the cleaning roller 11a through the primary transfer portion T1 or the cleaning portion is interrupted.

Hereinafter, the position at which the supply of the liquid developer is interrupted is referred to as a rear end of the liquid developer.

The cleaning blade 11b is separated from the cleaning roller 11a at an arbitrary timing T9 before the rear end of the liquid developer supplied to the cleaning roller 11a arrives (S46).

If an arbitrary timing T9 is set before the rear end of the liquid developer reaches the abutment position of the cleaning blade 11b, the cleaning blade 11b abuts on the cleaning roller 11a in the state in which the liquid developer is present at the abutment position of the cleaning blade 11b. Therefore, it is possible to reduce the frictional force between the cleaning blade 11b and the cleaning roller 11a. In the first embodiment, T9 is set substantially simultaneously with the timing at which the rear end of the liquid developer reaches the abutment position of the cleaning blade 11b. By the setting described above, it is possible to prevent an extra liquid developer from turning along the intermediate transfer member. In the first embodiment, the separation operation of the cleaning blade 11b is performed after the rear end of the liquid developer reaches the cleaning roller 11a and before the rear end of the liquid developer reaches the abutment position of the cleaning blade 11b. The timing at which the cleaning blade 11b is separated from the cleaning roller 11a may be the same as the timing at which the rear end of the liquid developer reaches the abutment position of the cleaning blade 11b.

The application of the cleaning bias is stopped at an arbitrary timing T10 after the rear end of the liquid developer reaches the transfer cleaning portion (S47).

At an application stop timing T13 of the charging bias, the charging of the photosensitive drum 1 is interrupted (S44).

Hereinafter, the position at which the charging portion of the photosensitive drum 1 is interrupted is referred to as a rear end of the charging portion of the photosensitive drum.

T14 is set so that the timing at which the rear end of the charging portion of the photosensitive drum 1 reaches the developing nip portion N2 is after the separation timing T8 of the developing roller 41.

The application of the primary transfer bias is stopped at an arbitrary timing T11 after the rear end of the liquid developer reaches the primary transfer portion T1 and before the rear end of the charging portion of the photosensitive drum 1 reaches the primary transfer portion T1 (S43). The application of the developing bias is stopped at an arbitrary timing T13 between the separation timings T8 to T14 of the developing roller 41 (S45).

The application of all of the charging bias, the developing bias, the primary transfer bias, and the cleaning bias is stopped, and the separation operation of the cleaning blade 11b and the cleaning roller 11a, and the separation operation of the developing roller 41 and the photosensitive drum 1 are completed. After the above operation is completed, the driving is stopped at an arbitrary timing T14. The separation sequence of the cleaning blade is completed, and the process proceeds to the standby state.

The inventors of the present application formed images on 100 sheets×1,000 sets of recording materials using the above-described image forming apparatus 100. Thereafter, the abrasion of the cleaning blade 11b, scratches of the cleaning roller 11a, generation of metal powder, and a change in surface roughness Rz of the cleaning roller 11a were investigated. In the experiment, the case in which the abutment and separation control of the cleaning blade of the first embodiment was performed and the case in which the cleaning blade was kept abutting in a comparative example were examined. The experiment results are shown in Table 1.

TABLE 1

| Perform or | | | | | Rz of |
|---|---|---|---|---|---|
| not perform | | | | | cleaning |
| abutment | Abrasion | Scratches | Generation | Rz of | roller |
| and | of | of | of | initial | after |
| separation | cleaning | cleaning | metal | cleaning | exami- |
| control | blade | roller | powder | roller | nation |
| Perform | Absent | Absent | Absent | 0.42 μm | 0.43 μm |
| Not | Present | Present | Present | 0.42 μm | 3.0 μm |
| perform | | | | | |

Existence and non-existence of abutment and separation control, Abrasion of cleaning blade, Scratch of cleaning roller, Generation of metal powder, Initial Rz of cleaning roller, Rz after examination of cleaning roller, Performance, No performance, Non-existence, Existence

As can be understood from the above Table 1, in the comparative example in which the abutment and separation control of the cleaning blade was not performed, after the examination, as the surface roughness of the cleaning roller is increased, the abrasion of the cleaning blade, the scratches of the cleaning roller, and the generation of the metal powder were observed. On the other hand, in the first embodiment in which the abutment and separation control of the cleaning blade is performed, the surface roughness was hardly changed, and the abrasion of the cleaning blade, the scratches of the cleaning roller, and the generation of the metal powder were not also confirmed.

As described above, in the first embodiment, the cleaning blade 11b is separated from the cleaning roller 11a before the supply of the liquid developer to the abutment portion between the cleaning roller 11a and the cleaning blade 11b is stopped. In addition, after the liquid developer was supplied to the cleaning roller 11a, the cleaning blade 11b was controlled to abut on the cleaning roller 11a. That is, the abutment between the cleaning blade 11b and the cleaning roller 11a is performed only in the state in which the liquid developer is supplied and the frictional force is reduced, and the abutment therebetween is not made in the state in which the liquid developer is not supplied and the frictional force is large. By controlling in this way, it is possible to suppress the abrasion of the cleaning blade, the scratches of the cleaning roller, the generation of the metal powder due to the frictional force between the cleaning blade and the cleaning roller.

### Second Embodiment

A second embodiment will be described.

Since an image forming apparatus of a second embodiment is common to the first embodiment except for a cleaning device and a controller, only the cleaning device and the controller will be described below. Further, a description of portions overlapping with the first embodiment will be omitted

### [Cleaning Device]

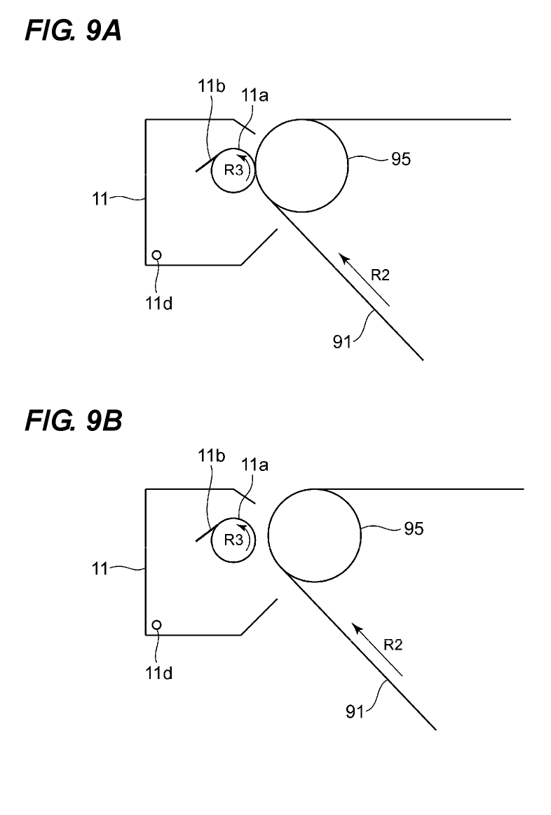

FIGS. 9A and 9B are each cross-sectional structural views of the cleaning device in the second embodiment. FIGS. 9A and 9B each show an abutment and separation state of a cleaning device 11 to be described below. The cleaning device 11 includes a cleaning container, a cleaning roller 11a, and a cleaning blade 11b. In addition, the cleaning device 11 is provided so as to be rotatable about a rotation shaft 11d. As the cleaning device 11 is rotated, the cleaning roller 11a abuts on an intermediate transfer member 91. The cleaning device 11 can move between a position (hereinafter, referred to as an abutment position) at which a secondary transfer residual toner on the intermediate transfer member 91 can be collected and a position (hereinafter, referred to as a separation position) at which the cleaning roller 11a is separated from the intermediate transfer member 91.

### [Controller]

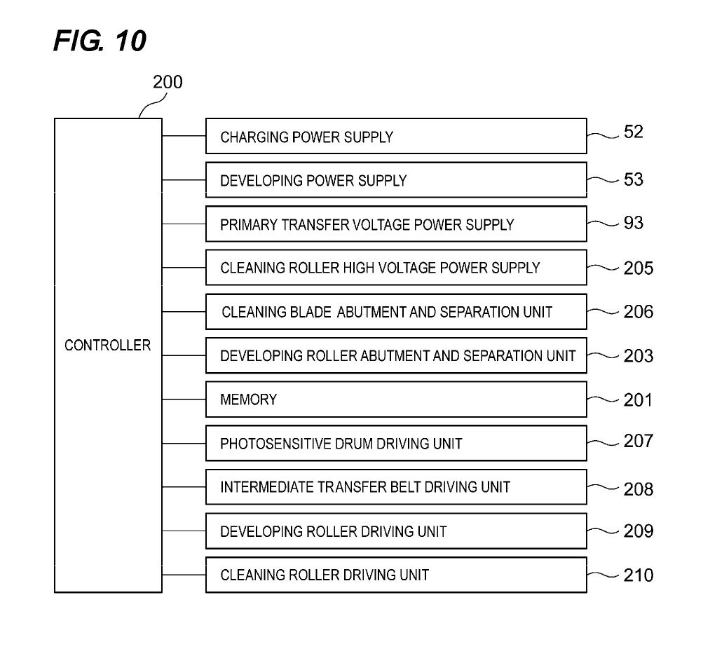

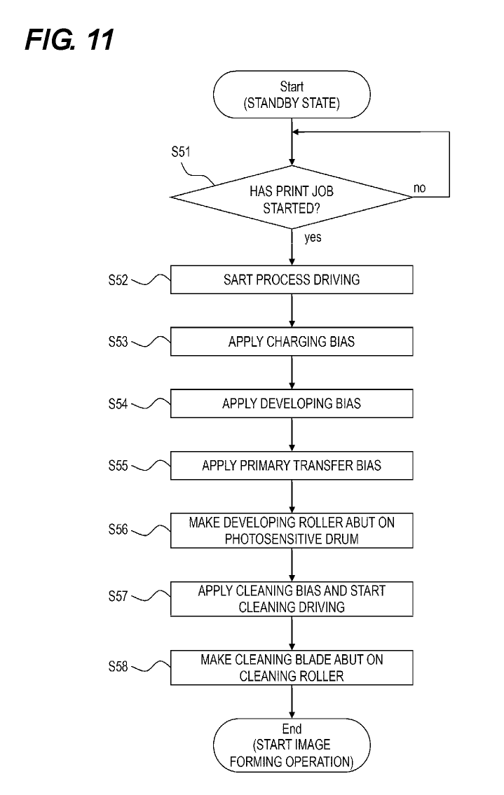

The control in the second embodiment will be described below with reference to a control block diagram (FIG. 10), a flowchart (FIG. 11), and a timing chart (FIG. 12). Since sequences of an abutment operation and a separation operation of the cleaning device 11 are different, they will be described separately.

First, an abutment sequence of the cleaning device will be described. FIGS. 11 and 12 are each diagrams illustrating a flow of the abutment sequence of the cleaning device and timings of each step of the sequence in the second embodiment.

An initial state of this sequence indicates a standby state before the print signal is received. At this time, driving of all of a photosensitive drum 1, a developing roller 41, the intermediate transfer member 91, and the cleaning roller 11a is stopped, and a charging bias, a developing bias, a temporary transfer bias, and a cleaning bias are not applied. Further, the developing roller 41 and the cleaning roller 11a are separated from the photosensitive drum 1 and the intermediate transfer member 91, respectively. In this state, since no liquid developer is supplied from the developing roller 41 to the photosensitive drum 1, no developer is supplied to the intermediate transfer member 91 or the cleaning roller 11a.

In the second embodiment, although the driving of the photosensitive drum 1, the developing roller 41, and the intermediate transfer member 91 is simultaneously input, the driving of the cleaning roller is independent of the above. Therefore, hereinafter, the former is referred to as process driving and the latter is referred to as cleaning driving.

When the controller 200 receives a print signal and a job is started, the process driving is started at time T1 (S52).

The charging bias is applied at an arbitrary timing T2 after the process driving ON (S53). As a result, a surface of the photosensitive drum 1 is charged. In this sequence, the photosensitive drum 1 is not exposed. By controlling in this way, a potential of the surface of the photosensitive drum 1 in the sequence is kept at a potential of a dark part.

The primary transfer bias is applied at an arbitrary timing T4 after a front end of the charging portion of the photosensitive drum 1 reaches the primary transfer portion T1 (S55). As a result, a primary transfer current is supplied to the photosensitive drum 1 through the primary transfer portion.

The developing roller 41 abuts on the photosensitive drum 1 at an arbitrary timing T5 after a front end of a primary transfer current supplying portion of the photosensitive drum 1 reaches a developing nip portion N2 (S56).

While the developing roller 41 abuts on the photosensitive drum 1, the liquid developer is continuously supplied to the photosensitive drum 1.

The developing bias is applied at an arbitrary timing T3 between the timings T2 and T5 (S54). At this time, as the potential of the surface of the photosensitive drum 1 is kept at a potential of a dark part, the liquid developer moving from the developing roller 41 to the photosensitive drum 1 contains almost no toner particles, and is mainly made of the carrier liquid.

The liquid developer supplied to the photosensitive drum 1 is supplied to the intermediate transfer member 91 through the primary transfer portion T1.

If the cleaning device moves from the separation position to the abutment position at an arbitrary timing T7 after a front end of the liquid developer reaches the intermediate transfer member 91 to make the cleaning roller abut on the intermediate transfer member 91, the cleaning driving is started simultaneously (S56).

In addition, the cleaning bias is applied at an arbitrary timing before T7 (S55).

The liquid developer supplied to the intermediate transfer member 91 reaches the cleaning blade via the cleaning roller.

The abutment sequence is completed at that time, and the process proceeds to an image forming operation or other preliminary operations.

Subsequently, the separation operation of the cleaning device will be described.

FIGS. 13 and 14 are each diagrams illustrating a flow of the separation sequence of the cleaning device 11 and timings of each step of the sequence in the second embodiment.

The initial state of this sequence refers to the image forming operation or other preliminary operations. At this time, both the process driving and the cleaning driving are input, and the charging bias, the developing bias, the primary transfer bias, and the cleaning bias are applied. Further, the developing roller 41 and the cleaning roller 11a abut on the photosensitive drum 1 and the intermediate transfer member 91, respectively. In this state, the liquid developer is continuously supplied from the developing roller 41 to the photosensitive drum 1, and the liquid developer is also supplied to the intermediate transfer member 91 or the cleaning roller 11a through the primary transfer portion T1 or the cleaning portion.

After the completion of the image forming operation or other preliminary operations, the photosensitive drum 1 is not exposed. As a result, the potential of the surface of the photosensitive drum 1 is kept at the dark part potential during the application of the charging bias, and the liquid developer moving from the developing roller 41 to the photosensitive drum 1 contains almost no toner particles, and is mainly made of the carrier liquid.

The developing roller 41 is separated from the photosensitive drum 1 at an arbitrary timing T8 after the completion of the image forming operation or other preliminary operations (S62). As a result, the continuous supply of the liquid developer from the developing roller 41 to the photosensitive drum 1 is interrupted.

The supply of the liquid developer from the developing roller 41 to the photosensitive drum 1 is interrupted, and thus the supply of the liquid developer to the intermediate transfer member 91 or the cleaning roller 11a through the primary transfer portion T1 or the cleaning portion is interrupted.

Hereinafter, the position at which the supply of the liquid developer is interrupted is referred to as a rear end of the liquid developer.

The cleaning device is separated from the intermediate transfer member 91 at an arbitrary timing T9 before a rear end of the liquid developer reaches the transfer cleaning portion, and the cleaning driving is stopped (S66). The timing at which the rear end of the liquid developer reaches the transfer cleaning portion and the timing at which the cleaning device is separated from the intermediate transfer member 91 may be the same. The application of the cleaning bias is stopped at an arbitrary timing T10 after T9 (S67).

At an application stop timing T13 of the charging bias, the charging of the photosensitive drum 1 is interrupted (S64).

Hereinafter, the position at which the charging portion of the photosensitive drum 1 is interrupted is referred to as a rear end of the charging portion of the photosensitive drum. T14 is set so that the timing when the rear end of the charging portion of the photosensitive drum 1 reaches the developing nip portion N2 is after the separation timing T8 of the developing roller 41.

The application of the primary transfer bias is stopped at an arbitrary timing T11 after the rear end of the liquid developer reaches the primary transfer portion and before the rear end of the charging portion of the photosensitive drum 1 reaches the primary transfer portion (S63). The application of the developing bias is stopped at an arbitrary timing T13 between the separation timings T8 to T14 of the developing roller 41 (S65).

The application of the charging bias, the developing bias, and the primary transfer bias is stopped, and the separation operation between the developing roller 41 and the photosensitive drum 1 is completed. After the above operation is completed, the process driving is stopped at an arbitrary timing T14. The separation sequence of the cleaning device is completed at that time, and the process proceeds to the standby state.

By the same method as in the first embodiment, abrasion of the cleaning blade 11b, scratches of the cleaning roller 11a, generation of metal powder, and a change in surface roughness Rz of the cleaning roller 11a were investigated. In the experiment, as the abutment timing T7 of the cleaning device 11 on the intermediate transfer member 91, the cases of (1) immediately after the front end of the liquid developer passes through the primary transfer portion, (2) immediately after the front end of the liquid developer passes through the secondary transfer portion, and (3) immediately after the front end of the liquid developer passes through the intermediate transfer member cleaning portion were examined. In addition, as a comparative example, the case of (4) in which the cleaning device 11 always abuts on the intermediate transfer member 91 and the process driving and the cleaning driving are simultaneously input and stopped was also examined. The experiment results are shown in Table 2.

TABLE 2

| | | | | | Rz of |
|---|---|---|---|---|---|
| Abutment | Abrasion | Scratches | Generation | Rz of | cleaning |
| and | of | of | of | initial | roller |
| separation | cleaning | cleaning | metal | cleaning | after |
| control | blade | roller | powder | roller | examination |
| (1) | Absent | Absent | Absent | 0.42 μm | 0.60 μm |
| (2) | Absent | Absent | Absent | 0.42 μm | 0.55 μm |
| (3) | Absent | Absent | Absent | 0.42 μm | 0.43 μm |
| (4) | Present | Present | Present | 0.42 μm | 3.0 μm |

Abutment and separation control, Abrasion of cleaning blade, Scratch of cleaning roller, Generation of metal powder, Initial Rz of cleaning roller, Rz after examination of cleaning roller, Non-existence, Existence

As can be understood from the above Table 2, in the comparative example in which the abutment and separation control of the cleaning device was not performed, after the examination, the abrasion of the cleaning blade, the scratches of the cleaning roller, the generation of the metal powder, and the increase in the surface roughness of the cleaning roller were observed. In contrast, in the second embodiment in which the abutment and separation control of the cleaning blade is performed, the abrasion of the cleaning blade, the scratches of the cleaning roller, and the generation of the metal powder were also not confirmed, and the change in the surface roughness was reduced.

In addition, when the abutment and separation control of the cleaning device is performed, the magnitude of the change in the surface roughness of the cleaning roller is observed depending on the abutment timing T7 of the cleaning device 11 on the intermediate transfer member 91. That is, as the abutment timing T7, the variation of Rz is smaller immediately after the front end of the liquid developer passes through (reaches) the secondary transfer portion than immediately after the front end of the liquid developer passes through (reaches) the primary transfer portion, and is even smaller immediately after the front end of the liquid developer passes through (reaches) the intermediate transfer member cleaning portion.

As described above, in the second embodiment, the abutment and separation state of the cleaning device with respect to the intermediate transfer member and the reaching timing of the front end and the rear end of the liquid developer are controlled. That is, the abutment timing of the cleaning device is set immediately after the front end of the liquid developer passes through the primary transfer position, more preferably after the front end of the liquid developer passes through the secondary transfer position, more preferably immediately after passing through the intermediate transfer member cleaning position. Further, the separation timing of the cleaning device is set before the rear end of the liquid developer passes through the intermediate transfer member cleaning position. By controlling in this way, it is possible to suppress the abrasion of the cleaning blade, the scratches of the cleaning roller, the generation of the metal powder due to the frictional force between the cleaning blade and the cleaning roller.

### Other Embodiments

Although each of the above-described embodiments describes the configuration in which the intermediate transfer belt is used as the intermediate transfer member, the intermediate transfer member may be, for example, an intermediate transfer drum formed in a drum shape.

The present embodiment describes a developing device 4 as a supply device which supplies a liquid developer to the intermediate transfer member, but is not limited thereto. For example, a dedicated supply device which supplies the liquid developer to the intermediate transfer member may be provided separately from the developing device.

Further, the abutment timing of the cleaning blade or the abutment timing of the cleaning roller may be the following timing. That is, it may be after the timing at which the supply operation of the liquid developer of the developing roller or the dedicated supply device is started. That is, in the case of supplying the carrier liquid from the developing roller to the cleaning roller, it may be after the supply timing of the liquid developer to the photosensitive drum. In addition, in the case of supplying the liquid developer from the dedicated supply device to the cleaning roller, it may be after the supply of the liquid developer to the intermediate transfer belt.

Further, in the first embodiment, the separation timing of the blade may be the same as in the second embodiment. That is, the abutment and separation of the blade may be performed like the abutment and separation timing of the cleaning roller. In this case, the configuration other than the separation of the blade may be the same as in the second embodiment.

According to the present invention, it is possible to suppress the defects caused by the rotation of the metal roller while the metal blade abuts on the metal roller in the state in which the liquid developer is not supplied to the metal roller.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-217015, filed Nov. 10, 2017, Japanese Patent Application No. 2018-107034, filed Jun. 4, 2018 which are hereby incorporated by reference herein in their entirety.

What is claimed is:

1. An image forming apparatus, comprising:
an image bearing member which bears an image;
a developing device which includes a developing roller bearing a liquid developer containing a toner and a carrier liquid and develops a latent image formed on the image bearing member;
an intermediate transfer belt to which a toner image formed on the image bearing member is transferred;
a cleaning roller which is applied a cleaning bias and configured to abut on the intermediate transfer belt and is made of a metal to collect a toner remaining on the intermediate transfer belt;
a blade which is provided to be able to abut on and be separated from the cleaning roller and is made of a metal to remove the liquid developer collected by the cleaning roller;
a separation mechanism which makes the blade abut on and be separated from the cleaning roller; and
a controller which controls the separation mechanism to make the blade abut on the intermediate transfer belt after the carrier liquid is supplied from the developing roller to the image bearing member, according to a start of an image formation.

2. The image forming apparatus according to claim 1, wherein the controller makes the blade abut on the intermediate transfer belt after a leading edge of the carrier liquid supplied from the developing roller to the image bearing member is supplied to the intermediate transfer belt, according to the start of the image formation.

3. The image forming apparatus according to claim 1, further comprising:
a secondary transfer portion which secondarily transfers the toner image transferred to the intermediate transfer belt to a recording material,
wherein the controller controls the separation mechanism to make the blade abut on the intermediate transfer belt after a leading edge of the carrier liquid supplied from the image bearing member to the intermediate transfer belt reaches the secondary transfer portion, according to the start of the image formation.

4. The image forming apparatus according to claim 1, wherein the controller controls the separation mechanism to make the blade abut on the intermediate transfer belt after a leading edge of the carrier liquid supplied from the image bearing member to the intermediate transfer belt reaches an abutment position at which the intermediate transfer belt abuts on the cleaning roller, according to the start of the image formation.

5. The image forming apparatus according to claim 1, wherein the controller controls the separation mechanism to make the blade abut on the cleaning roller after the carrier liquid supplied to the intermediate transfer belt is supplied to the cleaning roller and a leading edge of the carrier liquid supplied from the intermediate transfer belt to the cleaning roller reaches an abutment position at which the cleaning roller abuts on the blade, according to the start of the image formation.

6. The image forming apparatus according to claim 1, wherein the controller controls the cleaning bias to be applied to the cleaning roller before the blade abuts on the cleaning roller, according to the start of the image formation.

7. The image forming apparatus according to claim 1, wherein the controller makes the blade abut on the cleaning roller before a transfer residual toner of a first image of an image forming job reaches the cleaning roller, according to the start of the image formation.

8. An image forming apparatus, comprising:
an image bearing member which bears an image;
a developing device which includes a developing roller bearing a liquid developer containing a toner and a carrier liquid and develops a latent image formed on the image bearing member;
an intermediate transfer belt to which a toner image formed on the image bearing member is transferred;
a cleaning roller which is applied a cleaning bias and configured to be able to abut on and be separated from the intermediate transfer belt and is made of a metal to collect a toner remaining on the intermediate transfer belt;
a blade which abuts on the cleaning roller and is made of a metal to remove the liquid developer from the cleaning roller;
a separation mechanism which makes the cleaning roller abut on and be separated from the intermediate transfer belt; and
a controller which controls the separation mechanism to make the cleaning roller abut on the intermediate transfer belt after supplying the carrier liquid from the developing roller to the image bearing member, according to a start of an image formation.

9. The image forming apparatus according to claim 8, wherein the controller controls the separation mechanism to make the cleaning roller abut on the intermediate transfer belt after a leading edge of the carrier liquid supplied from the developing roller to the image bearing member is supplied to the intermediate transfer belt, according to the start of the image formation.

10. The image forming apparatus according to claim 8, further comprising:
a secondary transfer portion which secondarily transfers a toner image transferred to the intermediate transfer belt to a recording material,
wherein the controller makes the cleaning roller abut on the intermediate transfer belt after a leading edge of the carrier liquid supplied from the image bearing member to the intermediate transfer belt reaches the secondary transfer portion, according to the start of the image formation.

11. The image forming apparatus according to claim 8, wherein the controller controls the separation mechanism to make the cleaning roller abut on the intermediate transfer belt after a leading edge of the carrier liquid supplied from the image bearing member to the intermediate transfer belt reaches an abutment position at which the intermediate transfer belt abuts on the cleaning roller, according to the start of the image formation.

12. The image forming apparatus according to claim 8, wherein the controller controls the separation mechanism to make the cleaning roller abut on the intermediate transfer belt before a transfer residual toner of a first image of an image forming job reaches the cleaning roller, according to the start of the image formation.

13. The image forming apparatus according to claim 8, further comprising:
a driving source which drives the cleaning roller,
wherein the controller drives the cleaning roller after the carrier liquid is supplied from the developing roller to the image bearing member, according to the start of the image formation.

14. An image forming apparatus, comprising:
an image bearing member which bears an image;
a developing device which includes a developing roller bearing a liquid developer containing a toner and a carrier liquid and develops a latent image formed on the image bearing member;
an intermediate transfer belt to which a toner image formed on the image bearing member is transferred;
a supply device which supplies the carrier liquid to the intermediate transfer belt;
a cleaning roller which is applied a cleaning bias and configured to be able to abut on and be separated from the intermediate transfer belt and is made of a metal to collect a toner remaining on the intermediate transfer belt;
a blade which is provided to be able to abut on and be separated from the cleaning roller and is made of a metal to remove the liquid developer collected by the cleaning roller;
a separation mechanism which makes the blade abut on and be separated from the cleaning roller; and
a controller which controls the separation mechanism to make the blade abut on the cleaning roller after the carrier liquid is supplied from the supply device to the intermediate transfer belt, according to a start of an image formation.

15. An image forming apparatus, comprising:
an image bearing member which bears an image;
a developing device which includes a developing roller bearing a liquid developer containing a toner and a carrier liquid and develops a latent image formed on the image bearing member;
an intermediate transfer belt to which a toner image formed on the image bearing member is transferred;
a supply device which supplies the carrier liquid to the intermediate transfer belt;
a cleaning roller which is applied a cleaning bias and configured to be able to abut on and be separated from the intermediate transfer belt and is made of a metal to collect a toner remaining on the intermediate transfer belt;
a blade which abuts on the cleaning roller and is made of a metal to remove the liquid developer from the cleaning roller;
a separation mechanism which makes the cleaning roller abut on and be separated from the intermediate transfer belt; and
a controller which controls the separation mechanism to make the cleaning roller abut on the intermediate transfer belt after the carrier liquid is supplied from the supply device to the intermediate transfer belt, according to a start of an image formation.

16. An image forming apparatus, comprising:
an image forming portion configured to form an image on a recording material using liquid developer including toner and carrier liquid, wherein the image forming portion includes a rotating body configured to be able to bear the liquid developer including the toner and the carrier liquid, a supplying portion configured to able to supply the carrier liquid to the rotating body, a blade configured to be able to abut on and be separated from the rotating body and to clean the toner on the rotating body, and a separation mechanism configured to make the blade abut on and be separated from the rotating body; and
a controller configured to control the separation mechanism such that based on a signal indicative of starting an image formation, the carrier liquid is supplied from the supplying portion to the rotating body, and the blade abuts on the rotating body after a timing on which the carrier liquid supplied from the supplying portion to the rotating body reaches an opposing portion at which the blade is opposed to the rotating body.
